(19) United States
(12) Patent Application Publication
(10) Pub. No.: US 2008/0216533 A1
(43) Pub. Date: Sep. 11, 2008

(54) LOCK CYLINDER

(76) Inventor: Philip C. Ellis, Sinking Spring, PA (US)

Correspondence Address: Richard J. Veltman, Esq.;The Black & Decker Corporation, TW 199, 701 East Joppa Road, Towson, MD, 21286, US

(21) Appl. No.: 11/756,271

(22) Filed: May 31, 2007

Related U.S. Application Data
(60) Provisional application No. 60/894,026, filed on Mar. 9, 2007.

(51) Int. Cl. E05B 27/00

(52) U.S. Cl. 70/490

(57) ABSTRACT

A lock cylinder includes a cylinder housing having a plurality of upper pin chambers and a plug disposed for rotation in the cylinder housing. The plug includes at least one truncated pin chamber and a recess extending circumferentially from the opposite sides of the truncated pin chamber. The lock cylinder further includes a slider disposed in the recess, wherein the slider includes an aperture that cooperates with an upper pin chamber and the truncated pin chamber to define a generally continuous pin chamber. The plug is disposed in the cylinder housing for rotation along a first shear interface between a locked position and an unlocked position. The slider is disposed in the recess for circumferential movement and forms a portion of the first interface. The slider cooperates with the plug to define a second shear interface, with the plug moving relative to the slider along the second shear interface between the locked position and an interference position. The interference position is intermediate the locked position and the unlocked position.

This application is a continuation-in-part of co-pending Provisional Application Ser. No. 60/894,026 filed Mar. 9, 2007. The present invention is related to lock cylinders having tumbler pins that meet at a shear line to allow the lock to open.

### BRIEF DESCRIPTION OF THE DRAWINGS

FIG. 1 is a section taken along the longitudinal axis of a conventional lock cylinder.

FIG. 2 is an illustrative lock cylinder according to the present invention without a key in the keyway.

FIGS. 3-5 illustrate the sequence of unlocking the lock cylinder with a valid key in the keyway.

FIG. 6 illustrates a plug at an interference position

FIGS. 7-9 illustrate a slider.

### DETAILED DESCRIPTION OF THE DRAWINGS

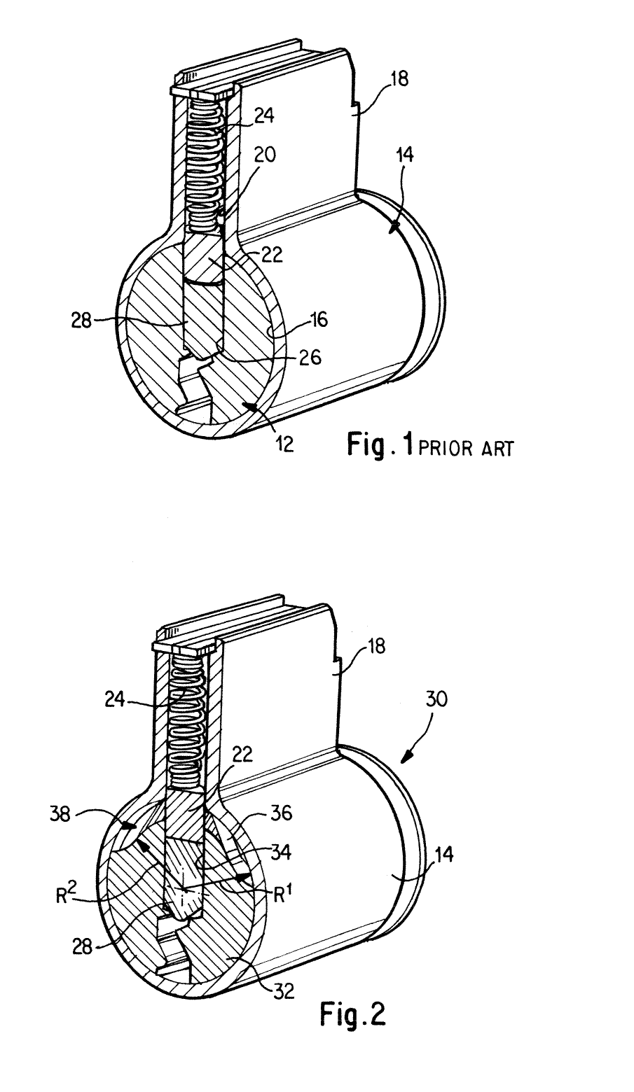

The present lock cylinder 10 includes a modified plug for an otherwise conventional lock cylinder. The conventional lock cylinder illustrated in FIG. 1 includes a cylinder housing 14 that cooperates with a plug 12 to define a shear interface 16 therebetween. As is known, the plug rotates inside the cylinder housing 14 along the shear interface between a locked, or home, position and an unlocked position. Rotation of the plug to the unlocked position typically drives a tailpiece that operates a conventional drive mechanism to retract a latch or bolt to unlock a door.

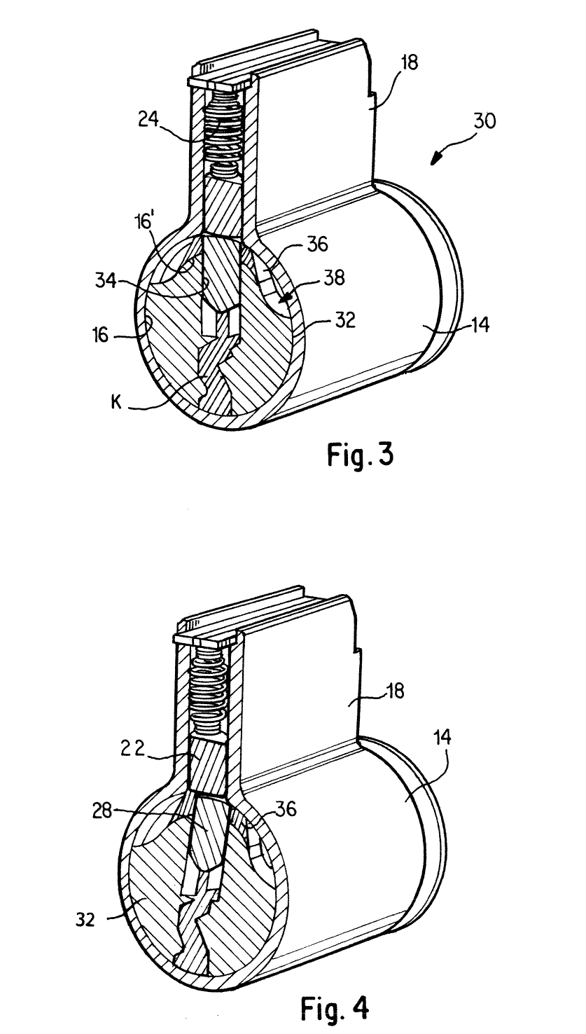

The cylinder housing 14 includes a chimney 18 with a plurality of upper pin chambers 20. Each upper pin chamber 20 contains an upper pin 22 and a spring 24 that biases the upper pin 22 radially inwardly toward the plug 12. The plug 12 includes a plurality of lower pin chambers 26 axially and rotationally aligned with the upper pin chambers 20 when the lock cylinder 10 is in the home position illustrated in FIG. 1. Each lower pin chamber contains a lower pin 28 that moves co-linearly with the upper pin 22 in the upper and lower pin chambers 20, 26. The lower pins 28 are sized so that the junction between the upper and lower pins 22, 28 lies along the shear interface 16 when a valid key K is inserted in the keyway, as illustrated in FIG. 3.

The lock cylinder 30 illustrated in FIGS. 2-5 differs from the conventional lock cylinder 10 of FIG. 1 by virtue of a modified plug 32, with remaining like parts having like reference numbers. The modified plug 32 includes at least one truncated pin chamber 34 and a slider 36 located at each truncated pin chamber 34.

The pin chamber 34 is truncated by forming a recess 38 that extends partially along the outer circumference of the plug 32 at the axial location of the truncated pin chamber 34. The ends of the recess can curve outwardly to meet the outer surface of the plug 32, as illustrated. The slider 36 is disposed in the recess 38 and is sized to allow movement in the recess 38 relative to the plug 32 and/or the cylinder housing 14.

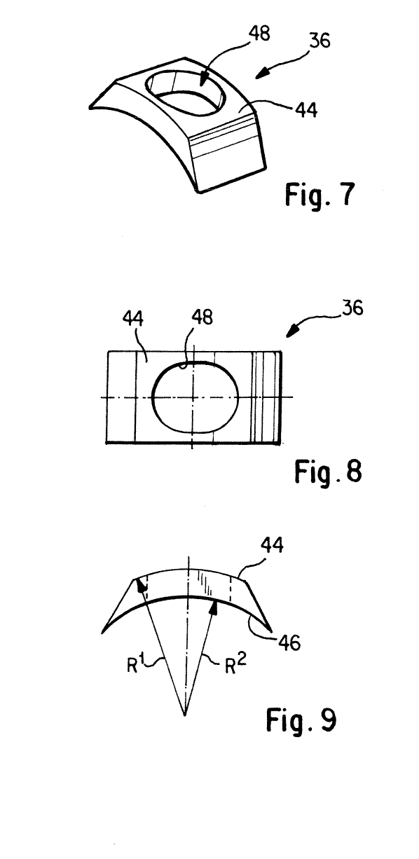

One embodiment of the slider 36, illustrated in FIGS. 7-9, includes arcuate upper and lower surfaces 44, 46, respectively. The upper arcuate surface 44 has a radius R¹ substantially equal to the inside radius of the cylinder housing 14 and forms a portion of the shear interface 16. The lower arcuate surface 46 has a radius R² substantially equal to the radius of the recess 38 and cooperates with the recess 38 to form a secondary shear interface 16′. The slider 36 moves relative to the plug 32 along the secondary shear interface 16′.

The slider 36 further includes an aperture 48 sized to receive the upper and/or lower pin 22, 28. The aperture 48 can be circular or non-circular. Preferably, the aperture 48 is elongated, or oblong, as illustrated in FIGS. 6-7. The elongated aperture 48 allows the upper pin 22 to more easily enter the aperture 48 if it is unsupported by the lower pin 28, even if the slider 36 moves slightly relative to the cylinder housing 14.

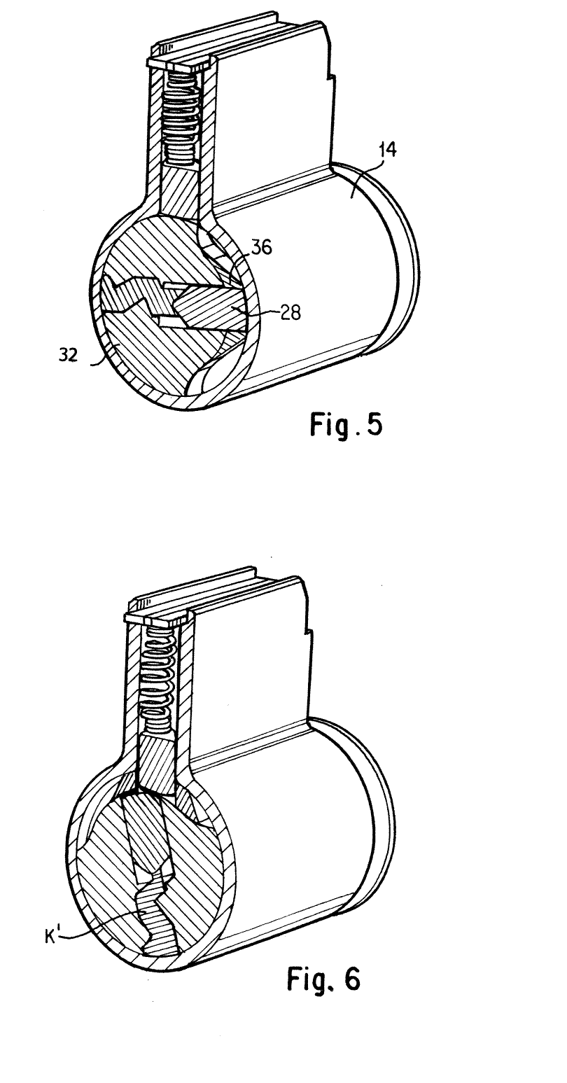

FIGS. 3-5 illustrate the rotation of the plug 32 in the cylinder housing 14 from the locked position (FIG. 3) to the unlocked position (FIG. 5). In the intermediate position (FIG. 4), the key K and lower pin 28 support the upper pin 22 until the plug is rotated sufficiently to clear the slider's aperture 48, thereby allowing the plug to continue rotating to the unlocked position.

FIG. 6 illustrates the plug 32 at an interference position, which occurs when an invalid key K′ is used in attempting to operate the lock cylinder 30. As illustrated, the invalid key K′ does not support the upper pin 22 sufficiently for the upper pin 22 to clear the first shear interface 16. With the upper pin 22 blocking the shear interface 16, the plug 32 can still rotate along the secondary shear interface 16′ relative to the slider 36, but only until the end of the slider 36 reaches the end of the recess 38, as illustrated. Although the plug 32 has rotated relative to the cylinder housing, the lock is still in the locked condition and will not retract the latch or bolt to unlock a door.

The above-described embodiments, of course, are not to be construed as limiting the breadth of the present invention. Modifications and other alternative constructions will be apparent that are within the spirit and scope of the invention as defined in the appended claims.

1. A lock cylinder comprising:
a cylinder housing including a plurality of upper pin chambers;
a plug disposed for rotation in the cylinder housing and cooperating with the cylinder housing to define a first shear interface, the plug rotating along the first shear interface between a locked position and an unlocked position, the plug including at least one truncated pin chamber and a recess extending circumferentially from the at least one truncated pin chamber; and
a slider disposed in the recess and including an aperture that cooperates with one of the plurality of upper pin chambers and the at least one truncated pin chamber to define a generally continuous chamber.

2. The lock cylinder of claim 1 wherein the slider includes a first surface that forms a portion of the first shear interface and a second surface that cooperates with the plug to define a second shear interface.

3. The lock cylinder of claim 1 wherein the slider moves at least partially along the length of the recess and includes an upper surface and a lower surface, wherein the upper surface cooperates with the cylinder housing to form a portion of the first shear interface.

4. The lock cylinder of claim 1 wherein the slider is configured for movement in the recess relative to the plug and/or the cylinder housing.

5. The lock cylinder of claim 1 wherein the aperture is non-circular.

6. The lock cylinder of claim 1 wherein the generally continuous chamber includes a non-circular cross section along at least a portion of its length.

7. A lock cylinder comprising:
a cylinder housing having a longitudinal axis;
a plug disposed for rotation in the cylinder housing along a first shear interface between a locked position and an unlocked position and including a circumferentially extending recess;
a slider disposed between the plug and the cylinder housing for movement in the recess, the slider forming a portion of the first shear interface and cooperating with the plug to define a second shear interface, the first shear interface being disposed at a first radial distance from the longitudinal axis and the second shear interface being disposed at a second radial distance from the longitudinal axis, the first radial distance being greater than the second radial distance.

8. The lock cylinder of claim 7 further including an upper pin disposed for radial movement in the cylinder housing, the plug being prevented from rotating to the unlocked position when at least a portion of the upper pin is disposed between the first and second shear interfaces.

9. The lock cylinder of claim 7 wherein the slider includes an aperture sized and configured to receive the upper pin to block the first shear interface.

10. The lock cylinder of claim 9 wherein the plug is rotatable along the second shear interface relative to the slider when the upper pin is blocking the first shear interface.

11. The lock cylinder of claim 7 wherein the slider moves relative to the cylinder housing along the first shear interface and relative to the plug along the second shear interface.

12. A lock cylinder comprising:
a cylinder housing having an upper pin and a longitudinal axis;
a plug having a lower pin and being disposed in, and cooperating with, the cylinder housing to define a first shear interface at a first radial distance from the longitudinal axis, the plug rotating in the cylinder housing along the first shear interface between a locked position and an unlocked position; and
a slider disposed between the plug and cylinder housing and forming a portion of the first shear interface, the plug being moveable relative to the slider along a second shear interface, the movement along the second shear interface being rotationally limited to movement between a locked position and an interference position, the interference position being intermediate the locked and unlocked positions.

13. The lock cylinder of claim 12 wherein the second shear interface is at a second radial distance from the longitudinal axis, the first radial distance being greater than the second radial distance.

14. The lock cylinder of claim 12 wherein the plug includes a recess and the slider is moveable in the recess relative to the plug and cylinder housing.

15. The lock cylinder of claim 12 wherein the cylinder housing includes an upper pin chamber and the plug includes a lower pin chamber aligned with the upper pin chamber and the slider includes an intermediate pin chamber aligned with the upper and lower pin chambers.

16. The lock cylinder of claim 15 wherein the intermediate pin chamber has a non-circular cross section.

17. The lock cylinder of claim 15 wherein a pin disposed in the intermediate pin chamber blocks the first shear interface to prevent the plug from rotating to the unlocked position.

18. A method of providing a lock cylinder comprising:
providing a cylinder housing including a plurality of upper pin chambers;
providing a plug disposed for rotation in the cylinder housing and cooperating with the cylinder housing to define a first shear interface, the plug being rotatable along the first shear interface between a locked position and an unlocked position, the plug including at least one truncated pin chamber and a recess extending circumferentially from the at least one truncated pin chamber; and
providing a slider disposed in the recess and including an aperture that cooperates with one of the plurality of upper pin chambers and the at least one truncated pin chamber to define a generally continuous chamber.

19. The method of claim 18 wherein the step of providing the slider includes the step of disposing the slider adjacent the plug to define a second shear interface between the slider and the plug.

20. The method of claim 19 further including the step of locating the second shear interface at a second radial distance from the longitudinal axis with the first radial distance being greater than the second radial distance.

21. The method of claim 18 wherein the step of providing the plug includes the step of configuring the slider and recess such that the slider is moveable in the recess relative to the plug and cylinder housing.

22. The method of claim 18 wherein the step of providing the cylinder housing includes the step of forming an upper pin chamber in the cylinder housing and the step of providing the plug includes the step of forming a lower pin chamber in the plug aligned with the upper pin chamber and the step of providing the slider plug includes the step of providing an intermediate pin chamber aligned with the upper and lower pin chambers.

23. The method of claim 22 further including the step of disposing a pin in the intermediate pin chamber to block the first shear interface and prevent the plug from rotating to the unlocked position.
